(19) United States
(12) Patent Application Publication
(10) Pub. No.: US 2024/0305131 A1
(43) Pub. Date: Sep. 12, 2024

(54) SYSTEM DIAGNOSIS METHOD IN AN ENERGY MANAGEMENT SYSTEM

(71) Applicant: SMA Solar Technology AG, Niestetal (DE)

(72) Inventor: Tobias Müller, Niestetal (DE)

(21) Appl. No.: 18/669,742

(22) Filed: May 21, 2024

Related U.S. Application Data
(63) Continuation of application No. PCT/EP2022/082629, filed on Nov. 21, 2022.

(30) Foreign Application Priority Data
Nov. 26, 2021 (DE) 10 2021 131 122.5

(51) Int. Cl. H02J 13/00; G05B 23/02

(52) U.S. Cl. CPC H02J 13/00002; G05B 23/0221; G05B 23/0254; H02J 13/00028; G05B 2223/04

(57) ABSTRACT

The present disclosure includes a system diagnosis method in an energy management system for electrical energy and at least one additional form of energy. The method includes acquiring actual values of one or more operating parameters; comparing the actual values with target values of the operating parameters in order to obtain a deviation; determining whether the deviation of the actual values of the operating parameters from the target values of the operating parameters exceeds a deviation threshold value; determining existence of a malfunction and where it is occurring when the deviation exceeds the deviation threshold value; assigning the malfunction to predefined malfunction groups based on the deviation; and producing a notification signal.

### REFERENCE TO RELATED APPLICATIONS

This Application is a Continuation of International Application number PCT/EP2022/082629, filed on Nov. 21, 2022, which claims the benefit of German Application number 10 2021 131 122.5, filed on Nov. 26, 2021. The contents of the above-referenced Patent Applications are hereby incorporated by reference in their entirety.

### FIELD

The disclosure relates to a system diagnosis method in an energy management system, and to an energy management system having system diagnosis.

### BACKGROUND

Energy management systems have become more complex over time. In particular so-called sector coupling, i.e. the connection between systems with different forms of energy and energy conversion mechanisms, creates a need for maintenance, fault diagnosis and monitoring processes and equipment.

KR10-2018-0069236 discloses, in this respect, an integrated monitoring system for photovoltaic systems. In this case, the temperature of solar cell modules in the photovoltaic system is used to determine whether or not a solar cell module is faulty. Other components of the system, such as a battery or a battery management unit, cannot be monitored, meaning that their status or operational readiness is unknown. A fault cannot be detected, and therefore the system cannot perform its function completely. In the worst case scenario, the system fails completely, causing major economic damage for the system operator without this being noticed. In a system having extended sector coupling, the damage would be even greater as, in addition to the monetary damage of the photovoltaic system failure, the heating system could fail, for example. This can be harmful to health.

### SUMMARY

This disclosure is directed to a system diagnosis system and method that makes it possible to monitor even complex energy management systems and ensure that they function properly or report malfunctions.

Here, in an energy management system for electrical energy and at least one additional form of energy, the system diagnosis method in the most general form comprises acquiring actual values of one or more operating parameters using the system diagnosis system; comparing the actual values of the operating parameters with target values of the operating parameters to find a deviation; determining whether the deviation of the actual values of the operating parameters from the target values of the operating parameters exceeds a deviation threshold value; and establishing that a malfunction exists and in which component of the energy management system the malfunction occurs when the deviation exceeds the deviation threshold value. The method also comprises assigning the established malfunction to predefined malfunction groups on the basis of the deviation of the operating parameter or parameters; and producing a notification signal in response to the established malfunction.

The system diagnosis method according to the disclosure makes it possible to effectively prevent a failure or a reduction in performance or the non-fulfillment of requirements of an energy management system. This prevention is realized by comparing an actual value of an operating parameter of a component of the system with a target value of the operating parameter of the component. In one embodiment, a target value for the operating parameter can be stored in a database. Alternatively, a target value can also result from temporary control instructions in the energy management system. For example, there may be a temporary control instruction not to feed any power into the grid.

In one embodiment, an actual value of an operating parameter can be acquired in various ways. For example, a value from a sensor can be acquired directly or indirectly, or the actual value can be sent from a component or read from a memory. From this comparison, a deviation threshold value can be used to deduce whether a malfunction is present.

In one embodiment, if there is no malfunction, the method is reset and a new actual value is acquired. The method then begins with the acquisition of actual values for operating parameters.

In one embodiment, if a malfunction is detected, it can, on the basis of the deviation, be assigned to one or more predefined malfunction groups. Finally, a notification signal is produced. This signal can be analog or digital. The type of signal is not limited to a specific signal and can be realized, for example, as an email notification, SMS notification, notification in a cloud or a portal, or as another notification.

It is therefore an advantage in one embodiment of the diagnosis method that individual components of an energy management system or control instructions in the system can be checked by an entity to ensure that they are functioning correctly. In other words, malfunctions of individual components of an energy management system can be acquired.

Furthermore, the diagnosis method according to one embodiment of the disclosure is not limited to one instance of the diagnosis method being executed at any one time. It is possible for a plurality of instances of the diagnosis method to run concurrently. In this case, one instance of the diagnosis method can be in one act, while another instance is in a different act of the diagnosis method. Both, or a plurality of instances, can also execute the same act. Furthermore, in one embodiment the plurality of instances of the diagnosis method do not have to monitor the same operating parameter or parameters. It is also possible for various operating parameters to be monitored by the plurality of instances of the diagnosis method.

In one embodiment, the operating parameter or parameters is or are one or more of a voltage, a current, an electrical power, a meter reading, a temperature, a condition, a utilization, and other electrical measurable or computable variables.

The aforementioned operating parameters such as voltage, current and temperature can be measured directly by sensors in one embodiment. Further operating parameters such as electrical power can be calculated from the aforementioned and other measurable operating parameters. The temperature can be measured, for example, from a temperature in the system, in a computer unit or in similar devices. A meter reading can include an electricity meter, a restart counter on a processor or computing unit or a sensor. Utilization can include the utilization of a processor, a computing unit or a charging device for an energy storage device in the system. The examples given in this case are not exhaustive and may include other directly measurable or calculable operating parameters.

In another embodiment, the operating parameter or parameters is or are estimated, predicted or calculated from one or more measurable variables, one or more specific system variables or one or more historic measured values.

In one embodiment, if certain malfunctions in a system are known, a development of certain operating parameters can be estimated, predicted or calculated from the analysis of historic operating parameters. This means that, if it is certain that a malfunction will occur, but before the malfunction fully affects the system, a notification signal can already be produced. In this sense, eliminating the potential cause of malfunctioning before the malfunction fully occurs can prevent financial loss, damage to a part of the energy management system, and the like.

Another embodiment shows that the acquisition acquires a course of actual values of one or more operating parameters, the comparison compares the course of actual values of the operating parameter or parameters with the course of target values of the operating parameter or parameters, and in the determination it is determined, by means of the system diagnosis, whether a deviation of the course of actual values of the operating parameters from the course of target values of the operating parameters exceeds a course deviation threshold value.

In this embodiment, in addition to individual values, courses of actual values can also be measured and processed. It is therefore possible to compare the course of the actual value of one or more operating parameters with a course of target values of this or these operating parameters. It is then determined whether the deviation between the course of the actual value and the course of the target value exceeds a course deviation threshold value. If the course deviation threshold value is exceeded, it is determined that a malfunction is present.

Another embodiment shows that the acquisition acquires one or more data sets of actual values of one or more operating parameters, the comparison compares the data set or data sets of actual values of the operating parameter or parameters with a data set of target values of the operating parameter or parameters, and during the determination it is determined, by means of the system diagnosis, whether a deviation of the data set or data sets of actual values of the operating parameters from the data set of target values of the operating parameters exceeds a data set deviation threshold value.

In this embodiment, data sets of actual values can also be measured and processed, in addition to individual values. It is therefore possible for a data set of the actual value of one or more operating parameters to be compared with a data set of target values for this or these operating parameters. It is then determined whether the deviation between the data set of the actual value and the data set of the target value exceeds a data set deviation threshold value. If the data set deviation threshold value is exceeded, it is determined that a malfunction is present. In this case, the data sets to be compared can be of any size and even of different sizes. In this case, if the data sets to be compared are of different sizes, excess data can be disregarded or both data sets to be compared can be reduced to a certain size so that a one-to-one comparison is possible. Another option for comparison is to evaluate the data sets statistically, for example, to compare a frequency distribution of rounded actual values with a frequency distribution of target values.

In another embodiment, the system diagnosis method is carried out independently of an energy management system controller.

The independence of the system diagnosis method from the energy management system controller in one embodiment makes it possible for the system diagnosis method to check the energy management system controller. In other words, a system diagnosis method implemented on a controller of a system would not be able to check the controller because the system diagnosis method, or the unit or program that executes it, would itself be affected by a malfunction of the controller. Consequently, the system diagnosis method, which is physically or software-wise separated from the controller, can even check a central controller for malfunctions, in addition to all connected system components.

In another embodiment, the one or more acquired operating parameters of one or more directly or indirectly connected components of the energy management system is or are acquired.

In this embodiment, it is specified that operating parameters can be acquired from directly or indirectly connected components of the energy management system. In other words, an operating parameter of a component directly connected to the system diagnosis, but also of a component that is indirectly connected to the system diagnosis via another component, can be acquired.

It is therefore possible, by way of example, to acquire the battery-temperature operating parameter from a battery that is connected to the system diagnosis via a battery management system. Remaining with this example, this is particularly advantageous as a malfunction of the battery management system can be determined by comparing the battery temperature, acquired directly from the battery, with the battery temperature reported by the battery management system. If a deviation greater than a deviation value occurs in this case, a malfunction of either the battery management system or the battery can be determined.

In another embodiment, the notification signal includes at least the malfunction group assigned to the malfunction as information.

The addition of the malfunction group in the notification signal is advantageous in one embodiment in that a user, a technical employee of a maintenance company, or even a light-emitting diode which emits different colored light according to the malfunction group, are informed of or provide information about the type of malfunction.

In another embodiment, the malfunction groups comprise at least a malfunction group of remediable software malfunctions, a malfunction group of non-remediable software malfunctions, and a malfunction group of hardware malfunctions, wherein the system diagnosis method, in the case of assignment of the malfunction to the group of remediable software malfunctions, comprises remedying the malfunction, in which the malfunction is remedied by means of algorithms, for example.

In this embodiment, various malfunction groups are defined, to which the malfunctions are assigned. The malfunction groups differ in the type of malfunctions assigned to them. The assignment of a malfunction to one of the malfunction groups is advantageous in that, after the assignment, it is known which measures are required to remedy the malfunction, or which type of notification signal is produced. For example, malfunctions that are assigned to the malfunction group of remediable malfunctions can be remedied independently by the system or remotely by an IT employee, i.e. without having to be on site. In contrast, in the event of hardware malfunctions, for example, it will be necessary for a service employee or the system operator to replace a system component, such as a cable, or to move it into the correct position.

In another embodiment, it is shown that, in the event of a malfunction, a controller of the energy management system will control one or more components of the energy management system in such a way that the malfunction is counteracted in such a way that at least a reduced functionality of the energy management system is maintained or that damage to the energy management system is prevented.

This embodiment offers the advantage that the damage, economic or to components, caused by a malfunction is minimized. The service life of other components in the system is extended, while the economic damage for the owner of the system is minimal.

In another embodiment, the notification signal is provided via a remote data connection or sent as a notification to a receiving device.

In this embodiment, the type of notification signal is specified. In this case, the notification signal can be provided via a remote data connection, such as the internet or the like, for example in a cloud. Alternatively or additionally, the notification signal can be sent as a notification to a receiving device, such as a smartphone, a pager, a tablet, a computer or the like.

Different options for providing the notification signal are advantageous in that an owner or operator of the system can choose the option most convenient for him for receiving the notification signal. This makes it possible to ensure that the likelihood of overlooking the notification signal is low.

In another embodiment, the notification signal includes one or more of the operating parameter, the malfunction group, the information that a malfunction has been determined, instructions for action to remedy the malfunction, and/or the component having the malfunction.

This embodiment specifies the content of the notification signal. This means that not only the information that a malfunction is occurring is transmitted but also additional information about the reasons, type and/or possible malfunction remedy measures. Remedying the malfunction or finding the cause of the malfunction can be faster or more efficient.

In another embodiment, if the malfunction is assigned to a specific malfunction group, the method can be carried out again with a different actual value in order to check whether the malfunction is triggered by a fault or whether the specific deviation resulting from a closed-loop controller, wherein the specific deviation results from a closed-loop controller does not represent a malfunction.

It can be the case that a deviation between the actual value and the target value results from a closed-loop control, for example, a safety regulation of a power to protect against overheating. In this case, there is no malfunction and no notification signal is produced. This is advantageous because an operator of the energy management system, an owner of the energy management system, or even a service employee, are not wrongly alerted by an unnecessary notification, and consequently the effort associated with a notification is also avoided.

One embodiment of the disclosure discloses an energy management system for electrical energy and at least one additional form of energy with system diagnosis, comprising the system diagnosis method according to the description above.

The above embodiment of the disclosure is concerned with an energy management system in which the system diagnosis method is applied in its most general form or according to any of the preceding embodiments. All embodiments and advantages can be used and applied in this system.

### BRIEF DESCRIPTION OF THE DRAWINGS

The disclosure is illustrated below with reference to the drawings, in which:

FIG. 1 shows a flow chart of a system diagnosis in general form,

FIG. 2 shows an example of an energy management system, and

FIG. 3 shows an example of a system diagnosis sequence.

### DETAILED DESCRIPTION

The figures are explained in detail below.

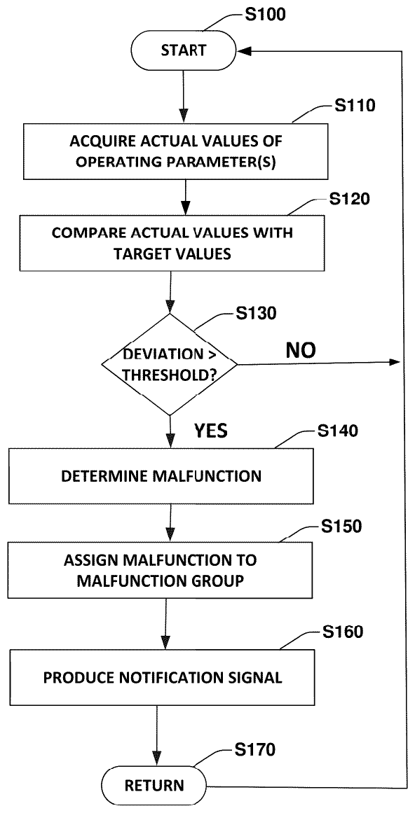

FIG. 1 shows the sequence of a system diagnosis method according to one embodiment of the disclosure. After the start of the system diagnosis method at S100, actual values of one or more operating parameters are acquired at S110.

The method then continues at S120, in which the acquired actual values of the operating parameter or parameters are compared with target values of the operating parameter or parameters. The method continues at S130.

At S130, it is established whether a deviation between the actual value and the target value of the operating parameter or parameters is greater than a deviation threshold value.

If the deviation between the actual and target value of the operating parameter or parameters is not greater than a deviation threshold value (NO at S130), the method is reset and starts again at S100.

If it is determined at S130 that the deviation between the actual and target value of the operating parameter or parameters is greater than a deviation threshold value (YES at S130), the method continues with at S140.

At S140, it is first determined whether there is a malfunction. Which component in the system has the malfunction is also determined. The method continues at S150.

At S150, the malfunction is assigned to a malfunction group. In this way, malfunctions that occur are categorized into groups, making it easier to remedy the malfunction. The method continues at S160.

Finally, a notification signal is produced at S160. The system diagnosis method is then reset at S170 and starts again at S100.

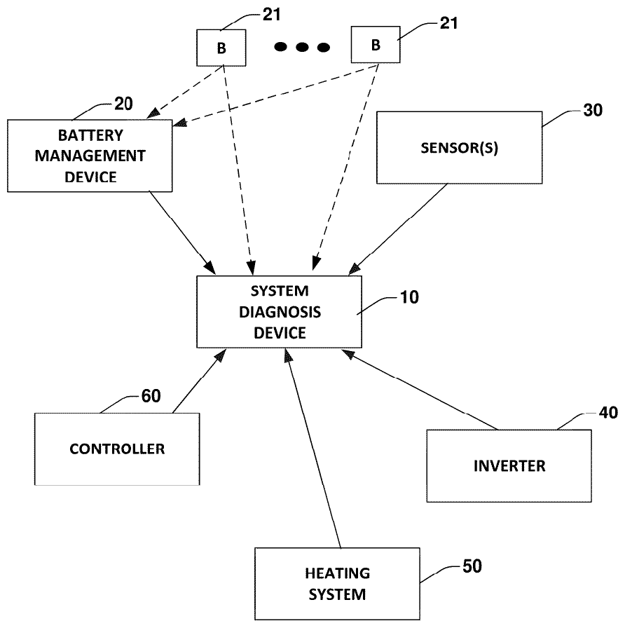

FIG. 2 illustrates an example of an energy management system 1. The components shown are to be regarded as being by way of example and not restrictive. The illustrated energy management system 1 shows a system diagnosis system, device, or circuit 10, a battery management system, device, or circuit 20 to which batteries (B) 21 are connected, one or more sensors 30, an inverter 40, a heating system 50, and a controller 60. In the components shown, arrows indicate a transmission of information.

It can therefore be seen that, for example, information comprising operating parameters or system boundary conditions or control instructions is transmitted directly or indirectly to the system diagnosis device 10 from all components in the energy management system 1. Information can be transmitted to the system diagnosis device 10 directly, as shown, from the battery management device 20, the one or more batteries 21, the sensor or sensors 30, the inverter 40, the heating system 50 or the controller 60.

It is also possible for information to be transmitted indirectly to the system diagnosis device 10. It is conceivable that the batteries 21 transmit their information to the battery management device 20 and that the battery management device 20 transmits this information to the system diagnosis device 10. The possibility of different information transmission paths is shown here by means of dashed arrows.

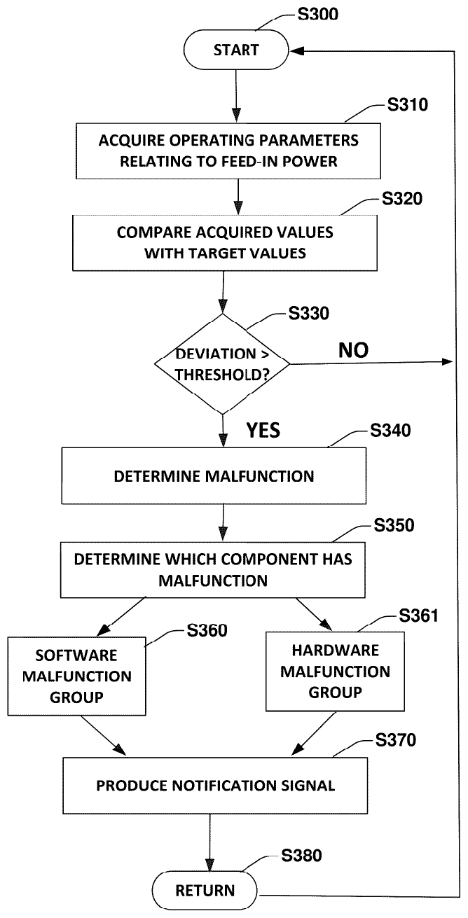

FIG. 3 shows a sequence of the system diagnosis function according to another embodiment. The sequence is part of the disclosure and is not to be understood as limiting. The sequence shown in FIG. 3 is intended as an example, to illustrate the function of the disclosure and to improve the understanding of the disclosure.

In this example, the controller has instructed that no power is to be fed into the grid. That is to say, a sensor at the grid connection point (NAP) should measure 0 W feed-in power.

The method starts at S300 and continues at S310. At S310, inter alia various operating parameters relating to the feed-in power are acquired. At S320, the actual values of the acquired operating parameters are compared with the target values of the operating parameters. Here, the target values of the operating parameters result from the boundary condition that no power is to be fed into the grid at the NAP. In other words, the grid feed-in power is zero. The method continues next at S330.

At S330, it is determined whether or not the deviations resulting from act S320 are greater than deviation threshold values. In this example, the deviation of the grid feed-in power from the target value 0 W exceeds the deviation threshold value (YES at S330). Consequently, there is a malfunction, which is determined at S340.

The component with the malfunction is determined at S350. Act S350 is shown as a single act in FIG. 3 for illustration purposes. The act that is carried out at S350 in FIG. 3 can also be carried out at S340, analogously to act S140 from FIG. 1. Possible options include an inverter and a sensor. In this example, the inverter may not have received the boundary condition, i.e. that the grid feed-in power is zero (inverter at S350). There is therefore a communication problem. The system diagnosis can send this boundary condition to the inverter via its own communication channels, and thus remedy the malfunction itself. In this case, it is a remediable software malfunction, and therefore the malfunction is assigned to this malfunction group at S360.

In another case, the sensor malfunctions (sensor at S350), and therefore the actual feed-in power fed in by the inverter via the NAP is zero, but the sensor displays values other than 0. Consequently, the sensor is faulty or defective, which is why there is a hardware malfunction, and the malfunction is therefore classified in the malfunction group of hardware malfunctions at S361.

A notification signal is produced next at S370. This notification signal contains the basic information that a malfunction has occurred. According to one or more embodiments, the malfunction group can further comprise the malfunction that has occurred, the component comprising the malfunction, and/or further information. The method then resets at S380 and returns to S300.

What is claimed is:

1. A system diagnosis method in an energy management system for electrical energy and at least one other form of energy, comprising:
acquiring actual values of one or more operating parameters using a system diagnosis device,
comparing the acquired actual values of the operating parameters with target values of the operating parameters using the system diagnosis device in order to find a deviation,
determining, using the system diagnosis device, whether the deviation of the actual values of the operating parameters from the target values of the operating parameters exceeds a deviation threshold value,
determining that there is a malfunction and in what part of the energy management system the malfunction occurs when the deviation exceeds the deviation threshold value,
assigning the determined malfunction to predefined malfunction groups on the basis of the deviation of the one or more operating parameters, and
producing a notification signal in response to the determined malfunction.

2. The system diagnosis method according to claim 1, wherein
the one or more operating parameters are one or more of a voltage, a current, an electrical power, a meter reading, a temperature, a condition, a utilization and other measurable or calculable variable.

3. The system diagnosis method according to claim 1, wherein
the one or more operating parameters are estimated, predicted or calculated from one or more measurable variables, one or more specific system variables, or one or more historic measured values.

4. The system diagnosis method according to claim 1, wherein
acquiring a course of actual values of one or more operating parameters during the acquisition,
comparing the course of actual values of the one or more operating parameters with the target values of the one or more operating parameters during the comparison, and
determining whether a deviation of the course of actual values of the one or more operating parameters from the target values of the one or more operating parameters exceeds a course deviation threshold value during the determination.

5. The system diagnosis method according to claim 1, wherein
acquiring one or more data sets of actual values of the one or more operating parameters during the acquisition,
comparing the acquired one or more data sets of actual values of the one or more operating with a data set of target values of the one or more operating parameters during the comparison, and
determining whether a deviation of the one or more data sets of actual values of the one or more operating parameters from the data set of target values of the one or more operating parameters exceeds a data set deviation threshold during the determination.

6. The system diagnosis method according to claim 1, wherein
the system diagnosis method is carried out independently of a control of the energy management system.

7. The system diagnosis method according to claim 1, wherein
the acquired one or more operating parameters comprise one or more parameters of one or more directly or indirectly connected components of the energy management system.

8. The system diagnosis method according to claim 1, wherein
the notification signal contains, as information, at least the malfunction group assigned to the malfunction.

9. The system diagnosis method according to claim 1, wherein:
the predefined malfunction groups comprise at least one malfunction group of remediable software malfunctions, one malfunction group of non-remediable software malfunctions, and one malfunction group of hardware malfunctions, and
remedying the malfunction by use of algorithms when the malfunction is assigned to the group of remediable software malfunctions.

10. The system diagnosis method according to claim 9, wherein
repeating the method with different acquired actual values, in order to check whether the malfunction is triggered by a fault or whether the deviation results from a closed-loop controller when the malfunction is assigned to a specific malfunction group,
wherein the deviation resulting from a closed-loop controller does not represent a malfunction.

11. The system diagnosis method according to claim 1, wherein the energy management system comprises a controller, the method further comprising
controlling one or more components of the energy management system using the controller, in the event of a determined malfunction, such that the malfunction is counteracted such that at least a reduced functionality of the energy management system is maintained or that damage to the energy management system is prevented.

12. The system diagnosis method according to claim 1, wherein
the notification signal is provided via a remote data connection or is sent as a notification to a receiving device.

13. The system diagnosis method according to claim 1, wherein
the notification signal contains one or more of the operating parameters, the malfunction group, information that a malfunction has been detected, instructions for action to remedy the malfunction, and/or identification of a component that has the malfunction.

14. An energy management system for electrical energy and at least one additional form of energy, having a system diagnosis system that executes a system diagnosis method, comprising:
acquiring actual values of one or more operating parameters by means of the system diagnosis,
comparing the acquired actual values of the operating parameters with target values of the operating parameters by means of the system diagnosis in order to find a deviation,
determining, by means of the system diagnosis, whether the deviation of the actual values of the operating parameters from the target values of the operating parameters exceeds a deviation threshold value,
determining that there is a malfunction and in what part of the energy management system the malfunction occurs when the deviation exceeds the deviation threshold value,
assigning the determined malfunction to predefined malfunction groups on the basis of the deviation of the one or more operating parameters, and
producing a notification signal in response to the determined malfunction.
